(19) United States
(12) Patent Application Publication
(10) Pub. No.: US 2024/0177029 A1
(43) Pub. Date: May 30, 2024

(54) ADAPTABLE AND EXPLAINABLE APPLICATION MODERNIZATION DISPOSITION

(71) Applicant: INTERNATIONAL BUSINESS MACHINES CORPORATION, Armonk, NY (US)

(72) Inventors: Anup KALIA, White Plains, NY (US); Mihir CHOUDHURY, Jersey City, NJ (US); Jin XIAO, White Plains, NY (US); Divya SANKAR, West Nyack, NY (US); John ROFRANO, Mahopac, NY (US); Venkata Nagaraju PAVULURI, New Rochelle, NY (US); Lambert POUGUEM WASSI, Yonkers, NY (US); Maja VUKOVIC, New York, NY (US); Michele MERLER, New York City, NY (US)

(21) Appl. No.: 18/071,911

(22) Filed: Nov. 30, 2022

(51) Int. Cl. G06N 5/04; G06F 40/40

(52) U.S. Cl. CPC G06N 5/045; G06F 40/40

(57) ABSTRACT

A method includes receiving a natural language problem statement corresponding to application modernization needs of a user, the natural language problem statement including at least one technical entity, business constraint and disposition information; providing structured information by extracting information from the natural language problem statement using a neural word segmentation method; generating standardized technical entities, standardized business entities, and standardized dispositions by inputting the structured information to at least one machine learning model; and generating at least one recommended disposition of at least one technical entity to a second technical entity based at least on a business constraint corresponding to the natural language problem statement using the standardized technical entities, business entities, and dispositions. Optionally, the at least one recommended disposition corresponds to one or more possible target environments along with explanation generated based on the business constraints and mentions of technical entities present in the natural language problem statement.

### BACKGROUND

Aspects of the present invention relate generally to managing legacy computing applications and, more particularly, to using an artificial intelligence (AI) system to guide users in a best way to modernize their applications to make them more maintainable and usable.

Enterprises and individuals integrate various software applications and hardware environments into regular use, migrating from purely manual processes. Both software and hardware environments may experience upgrades and modifications over time.

### SUMMARY

In a first aspect of the invention, there is a computer-implemented method including: receiving, by a processor set, a natural language problem statement corresponding to application modernization needs of a user, the natural language problem statement including at least one technical entity, business constraint, and disposition information; providing, by the processor set, structured information by extracting information from the natural language problem statement using a neural word segmentation method; generating, by the processor set, standardized technical entities, standardized business entities, and standardized dispositions by inputting the structured information to at least one machine learning model; and generating, by the processor set, at least one recommended disposition of at least one technical entity to a second technical entity based at least on a business constraint corresponding to the natural language problem statement using the standardized technical entities, standardized business entities, and standardized dispositions.

In another aspect of the invention, there is a computer program product including one or more computer readable storage media having program instructions collectively stored on the one or more computer readable storage media. The program instructions are executable to: receive a natural language problem statement corresponding to application modernization needs of a user, the natural language problem statement including at least one technical entity, business constraint and disposition information; provide structured information by extracting information from the natural language problem statement using a neural word segmentation method; generate standardized technical entities, standardized business entities, and standardized dispositions by inputting the structured information to at least one machine learning model; and generate at least one recommended disposition of at least one technical entity to a second technical entity based at least on a business constraint corresponding to the natural language problem statement using the standardized technical entities, standardized business entities, and standardized dispositions, the at least one recommended disposition corresponding to one or more possible target environments along with explanation generated based on the business constraints and mentions of technical entities present in the natural language problem statement.

In another aspect of the invention, there is system including a processor set, one or more computer readable storage media, and program instructions collectively stored on the one or more computer readable storage media. The program instructions are executable to: receive a natural language problem statement corresponding to application modernization needs of a user, the natural language problem statement including at least one technical entity, and business constraint; provide structured information by extracting information from the natural language problem statement using a neural word segmentation method; generate standardized technical entities, and standardized business entities, by inputting the structured information to at least one machine learning model; query at least one knowledge database with the structured information extracted from the natural language problem statement; retrieve structured information corresponding to the natural language problem statement from the at least one knowledge database; and generate at least one recommended disposition of at least one technical entity to a second technical entity based at least on the structured information corresponding to the natural language problem statement from the at least one knowledge database, a business constraint corresponding to the natural language problem statement using the standardized technical entities and standardized business entities.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment, according to an embodiment of the present invention.

FIG. 2A illustrates an example process for modernization with a disposition to rebuild and replace a current system.

FIG. 2B illustrates an example process for modernization with a disposition to rehost the current software.

FIG. 3 shows a block diagram of an exemplary environment in accordance with aspects of the invention.

FIG. 4 is a flow diagram depicting an exemplary method for application modernization disposition, according to an embodiment of the present invention, where targets are not provided.

FIG. 5 is a flow diagram depicting an exemplary method for application modernization disposition, according to an embodiment of the present invention, where the client provides preferred targets.

FIG. 6 illustrates a set of reformatted questions that correspond to the client's problem to be solved, according to an embodiment of the present invention.

FIG. 7 is a flow diagram depicting a method for application modernization workflow planning, according to an embodiment of the present invention.

FIG. 8A shows an exemplary set of reformatted questions to describe the client's problem, according to an embodiment of the present invention.

FIG. 8B illustrates cost of transformation questions in the form of replatform and refactor disposition tasks, according to an embodiment of the present invention.

FIGS. 9A-C depict a series of flow diagrams illustrating active learning for application modernization machine learning models, according to an embodiment of the present invention.

FIG. 10 is a flow diagram illustrating online neural word segmentation, according to an embodiment of the present invention.

FIGS. 11A-B illustrate flow diagrams of few-shot learning, according to an embodiment of the present invention.

FIG. 12 is a flow diagram illustrating a method for question generating, according to an embodiment of the present invention.

FIG. 13 is a block diagram depicting an environment to provide functionality of an application modernization disposition process including various program instruction modules and their interaction with knowledge base databases, according to an embodiments of the present invention.

### DETAILED DESCRIPTION

Aspects of the present invention relate generally to managing legacy software applications and, more particularly, to using an artificial intelligence (AI) system to guide users in a best way to modernizing the applications and their operating environments to make them more maintainable and usable.

Over time software applications and the hardware environments in which they operate may become obsolete and hard to maintain or become interoperable with other necessary systems. An enterprise or organization, and even individuals, may require the advice of expensive third-party consultants to recommend a path to modernization of their software/hardware environment. In many cases, newer technologies provide opportunities for an enterprise to reduce operating costs of their software applications, or host them in a cloud environment, or use containers or virtual machine environments for hosting to make operations more efficient, more easily accessible, and less expensive. In some cases, upgrading of hardware is necessary to enable a software application to continue to operate. In some cases, an upgrade of the software is required to keep it operable with integrated systems. As personnel change in an organization, corporate memory may degrade over time, reducing or completely eliminating experts in the legacy systems. In many cases, in-house staff in an organization will no longer be able to maintain systems using obsolete or archaic languages, such as COBOL or FORTRAN, etc. It may be necessary to migrate software to newer languages or other platforms for a business to continue to operate.

Current methods to identify when and to what software to migrate can be cumbersome and require a third-party consultant. In an example scenario, a static pre-filled questionnaire is used by a subject matter expert (SME) with particular domain expertise of the applications in question. As such, this sort of limited questionnaire may provide less coverage for unknown domains. For example, some questionnaires might be specific to Mainframe/COBOL based applications whereas some might be specific to .NET/J2EE applications. Real world applications are often complex polyglots. In some cases, a client might additionally provide configuration management database (CMDB) information to specify their current state of operations regarding their legacy software environment.

Other migration criteria may involve unknown business constraints, non-technical entities, or technical entities. The relationship between business constraints and technical entities may or may not be given. For example, moving from COBOL to Java or C# or moving from VSAM to MySQL or COBOL would be dependent on a set of business constraints e.g., licensing cost, (un)availability of Information Technology (IT) resources, high scalability, and availability requirements. In current systems, this information may be input to a static rule-based engine to provide a solution. In this example, a static rule-based engine is typically a set of program instructions, or software module that comprises a number of if-then-else statements.

Often the disposition recommendations from these static rule-based engines are agnostic of the underlying state of legacy applications/business constraints and hence lack explainability. This could be an important reason for lack of adoption of specific tools. Moreover, the static rule-based engines often require an inordinate number of rules where the input data must be manually cleaned and formatted to be recognized by the rule engine. The recommendations may also require manual manipulation of output information from the rule engine. Even the rule-based engine may require a significant amount of resources to maintain just to understand the constraints and technology input by the client.

According to aspects of the invention, the AI-based system as described herein may provide a number of advantages over existing methods to modernize an enterprise software or hardware environment. In one aspect, the AI-based system provides a knowledge base manually bootstrapped from use case studies that contains disposition recommendations from one technical entity to another given a business constraint. In this context, bootstrapping the knowledge base may entail manually formatting empirical and experiential use case study information and entering the information into the knowledge base. This use case study information may result from activities of the knowledge base manager/owner or derived from use case studies received by third parties. The information may also be automatically formatted after review for relevance and utility by a human using an automated tool. In this way, the knowledge base may be seeded with information that defines technical entities, business constraints and their relationships to one another and to disposition information taken from actual use cases, prior to any augmentation of the knowledge base using machine learning.

In another aspect, input descriptions from a client may be considered, with respect to current state of its applications, where the AI-based system recommends a disposition to one or more possible target environments along with explanation. The recommendation is generated based on business constraints and mentions of technical entities present in the input description. Another aspect may consider input description from a client with a preference of one or more target environments stated by the client. In other words, the client provides user disposition preferences which may include a preference for one or more various aspects of the disposition including target language for translation, target host environment, etc. The output disposition recommendation considers such target environments and preferences to validate them and suggests appropriate recommendations to clients along with explainability. Another aspect considers input description from a client with a preference of transformation paths i.e., given by clients. In this case, recommendation may consider such transformation paths and validate them to provide appropriate recommendations to clients along with explainability.

In other aspects, the AI-based system may provide a workflow plan once the target environments and the transformation path has been decided. The plan may be optimized based on different criteria such as costs, resources, time, etc. In another aspect, the AI-based system may provide an active learning mechanism to learn and validate new information in terms of new business constraints, technical entities, transformation paths, preferences and so on to improve an existing knowledge base. In another aspect, a mechanism may be provided which connects users with universal knowledge bases such as Wikidata and Stackoverflow for knowledge acquisition and validation. In another aspect, an existing knowledge base may be augmented by simulating entity combinations as queries to universal knowledge bases such as Stackoverflow to generate more knowledge. Stackoverflow is a question-and-answer website for professional and enthusiast programmers, primarily used by those learning how to code, or who want to share knowledge or collaborate with others. Stackoverflow uses crowdsourced information. Wikidata is a free and open knowledge base that can be read and edited by both humans and machines. Wikidata acts as central storage for the structured data of its Wikimedia sister projects including Wikipedia, Wikivoyage, Wiktionary, Wikisource, and others.

In one implementation, a method is provided for application modernization dispositions, where the method includes: receiving client input describing a current state; extracting an entity from the client input; extracting a constraint from the client input; identifying an entity-constraint relationship from a knowledge base; identifying an entity-disposition relationship according to the entity constraint relationship; and generating a workflow according to the entity disposition relationship.

Implementations of various embodiments may provide an improvement in the technical field of legacy technology modernization. In particular, implementations use machine learning (ML) to train an AI-based machine learning model for application modernization to automatically provide recommendations for modernizing legacy computing applications used by an enterprise or individual. The modernization recommendations may include suggestions for replacement of software applications, application upgrades, hardware replacements or upgrades, and/or a path to get from the legacy technology to modernized technology, etc. Using a trained ML model enables a quick, near real-time output of recommendations using hundreds or thousands of similar use cases as a basis, having thousands or millions of variables related to business constraints and technology. These near real-time modernization recommendations, allow one to eliminate old, inefficient, or obsolete technology without the need to hire expensive consultants or to hire a team of technologists well-versed in obsolete technologies to provide modernization solutions. Modernization of legacy technology may improve data security and privacy by implementing up-to-date hardware or software technologies, as well as reduce computational or operational inefficiencies caused by using outdated or obsolete technologies. Implementations may transform an article to a different state or thing. In particular, implementations may cause an ML model to automatically provide solution information to a user via electronic messaging, e.g., e-mail, text or MSM messaging, electronic notifications, or other communication methods. Implementations may store historical data to a memory storage to assist in retraining an AI-Based ML model. The historical data is updated dynamically and stored as additional use cases of technology modernization as modernization of applications are initiated or completed.

Implementations of the present invention are necessarily rooted in computer technology. For example, the steps of application modernization disposition, knowledge creation, and active learning, at least, are computer-based and cannot be performed in the human mind. Training and using a ML model are, by definition, performed by a computer and cannot practically be performed as a mental process (or with pen and paper) due to the complexity and massive amounts of calculations involved. For example, an artificial neural network may have millions or even billions of weights that represent connections among nodes in one or more layers of the model. Values of these weights are adjusted, e.g., via backpropagation and stochastic gradient descent, when training the model, and are utilized in calculations when using the trained model to generate an output in real time (or near real time). Given this scale and complexity, it is simply not possible for the human mind, or for a person using pen and paper, to perform the number of calculations involved in training and/or using a ML model. For purpose of brevity, the term “neural network” may be used herein as an equivalent to the more accurate term of “artificial neural network” to indicate a computer-based artificial intelligence methodology.

It is to be understood that the aforementioned advantages, as well as other advantages described herein, are example advantages and should not be construed as limiting. Embodiments of the present disclosure can contain all, some, or none of the advantages while remaining within the spirit and scope of the present disclosure.

It should be understood that, to the extent implementations of the invention collect, store, or employ personal information provided by, or obtained from, individuals (for example, business constraints and application information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

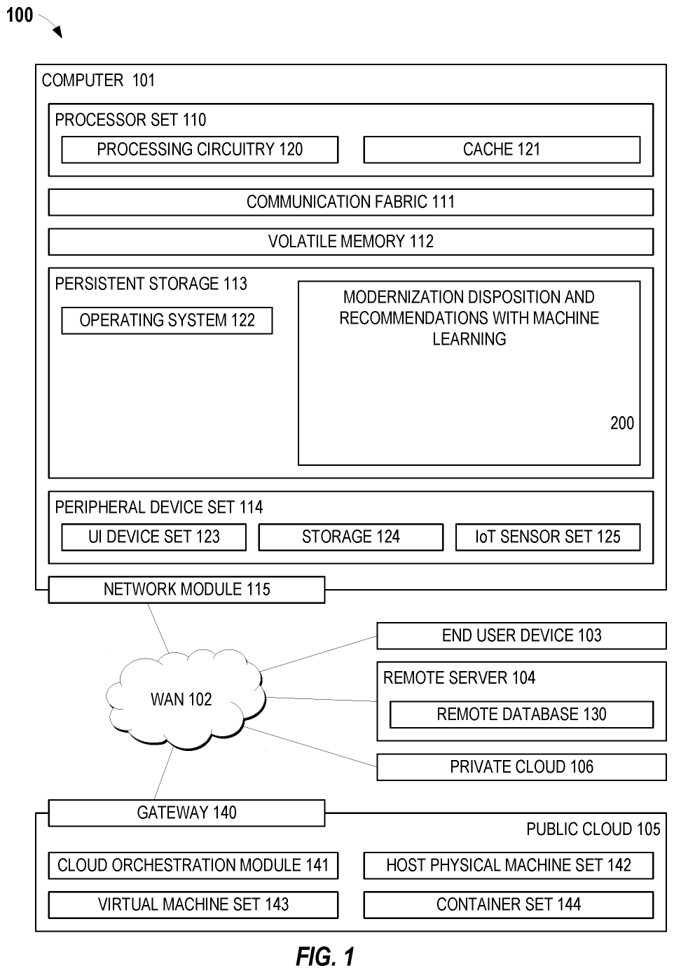

FIG. 1 depicts a computing environment 100 according to an embodiment of the present invention.

Computing environment 100 contains an example of an environment for the execution of at least some of the computer code involved in performing the inventive methods, such as application modernization disposition and recommendations with machine learning 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

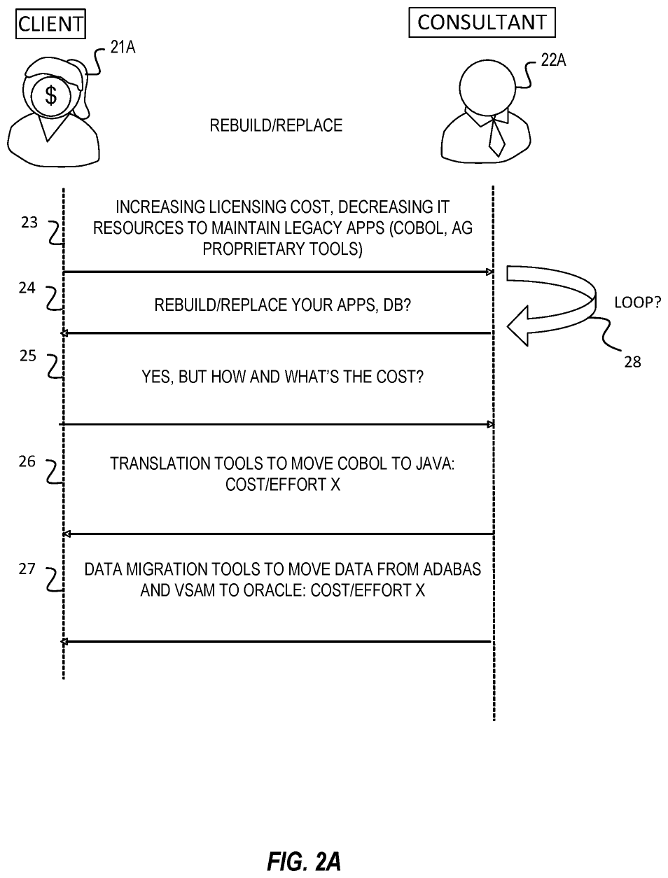

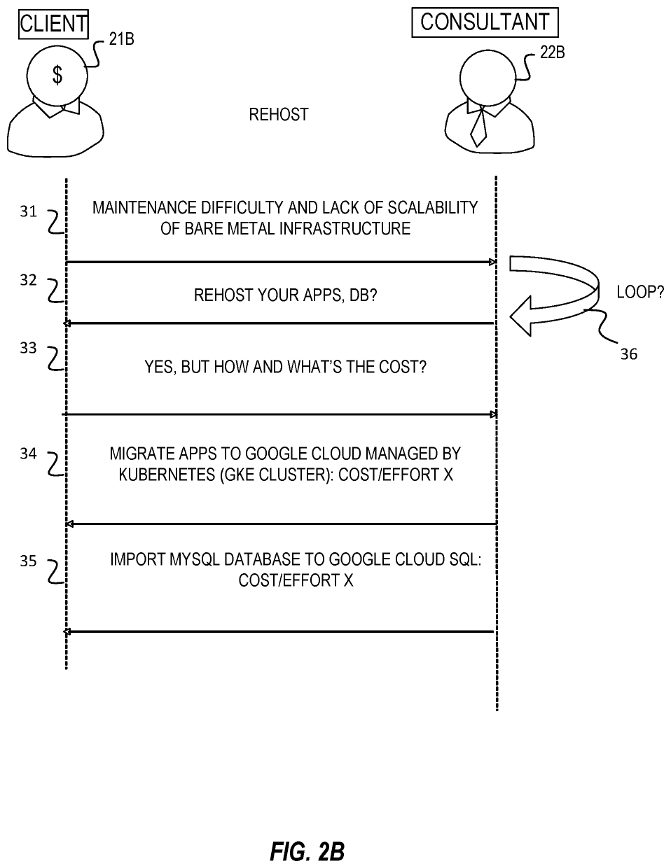

FIG. 2A illustrates an example process for modernization with a disposition to rebuild and replace a current system. Client 21A typically hires a consultant 22A to help modernize an application. Client 21A identifies problems and business criteria such as increasing licensing costs, decreasing IT resources necessary to maintain the legacy applications (e.g., COBOL, AG Proprietary tools, etc.) in block 23. Client 21A might provide these issues via a questionnaire provided by Consultant 22B. The Consultant 22A may recommend rebuilding and/or replacing the client's applications or database in block 24. Client 21A typically asks consultant 22A what the cost of rebuilding and replacing will be in block 25. If the cost is too high, the recommendation and cost query may be repeated as in loop 28.

Once the solution is balanced by cost by Client 21A, translation tools to move the legacy code to more modernized code (e.g., COBOL to JAVA) may be selected and performed in block 26. Data migration tools to move data from a legacy database to a more modernized database (e.g., ADABAS and VSAM to ORACLE) may be selected and performed in block 27.

FIG. 2B illustrates an example process for modernization with a disposition to rehost the current software. Client 21B typically hires a consultant 22B to help modernize an application and/or application environment. Client 21B identifies problems and business criteria such as maintenance difficulty and lack of scalability of bare metal infrastructure) in block 31. Client 21B might provide these issues via a questionnaire provided by Consultant 22B. The Consultant 22B may recommend rehosting the applications and database into a newer hardware or virtual machine environment in block 32. Client 21B typically asks consultant 22B what the cost of rehosting will be in block 33. If the cost is too high, the recommendation and cost query may be repeated as in loop 36.

Once the solution is balanced by cost by Client 21B, the applications may be migrated from the legacy environment to a more up-to-date environment that is easier to maintain (e.g., migrate to Google Cloud managed by Kubernetes, a GKE cluster, in block 34. A legacy database may be imported into a more maintainable database, e.g., import MYSQL to Google Cloud SQL, in block 35.

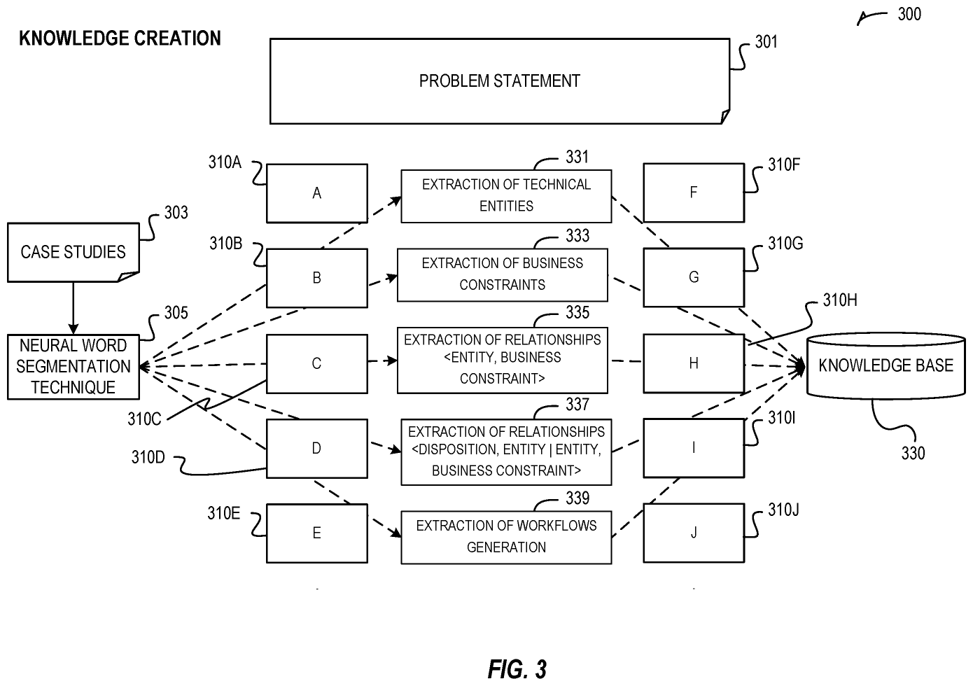

As described more fully with respect to FIGS. 3-13, one or software modules or set of program instructions provide an application modernization disposition system and method as in block 200 of FIG. 1. In an embodiment, application modernization disposition process 200 comprises program instructions which are stored in at least one non-volatile memory store, or computer readable medium 113 communicatively coupled to computer 101. In an embodiment, one or more modules may be executed on the processor set 110. In embodiments, one or more modules may be executed remotely on a server device or as a cloud service on a remote server communicatively coupled over a network 102 with computer 101. The application modernization disposition process 200 receives natural language input and may provide output of one or more disposition recommendations, disposition workflow planning, knowledge augmentation, and AI-based model training sets. The application modernization disposition process 200 may include modules for neural word segmentation; machine learning model (e.g., few-shot learning models); model training; disposition generation; disposition workflow planning; question generation; active learning of technical entities, business constraints, disposition knowledge; and knowledge creation.

FIG. 3 shows a block diagram of an exemplary environment 300 in accordance with aspects of the invention. In an example the client provides a natural language problem statement 301, also referred to as a “problem statement” herein for simplicity, which comprises the text “find a pathway off the legacy mainframe due to increasing license costs, maintenance fees, and the limited ability to modernize its legacy applications and integrate them with other platforms. In addition, the company was tied to a specific proprietary technology and desired to free itself from the vendor lock-in. Finally, the decreasing availability of IT resources with experience in maintaining legacy technology was beginning to increase the risk of keeping the applications running.” In this example request, natural language processing (NLP) and natural language understanding (NLU) are used to extract knowledge from this request/query. For instance, the NLP/NLU is used to recognize and extract technical entities, business constraints and relationships between and among entities. In this example, the NLP/NLU recognizes technical entities of mainframe; and business constraints of increasing licensing cost, maintenance fees, vendor lock-in, proprietary technology.

In this example, there were 18 highly significant applications that had to be migrated from the z/OS platform to Linux, from the Natural Programming Language to Java, and from Adabas and VSAM data structures to Oracle. It will be understood by one of skill in the art that Natural Programming Language is an ontology-assisted way of programming in terms of natural-language sentences, e.g., English. A structured document with content, sections, and subsections for explanations of sentences forms a natural language processing (NLP) document, which is actually a computer program. This case study may be added to knowledge base 330 to assist in making recommendations and dispositioning migrations for other clients or projects. In an embodiment, knowledge base 330 is a database of structured information curated from modernization cases studies. Knowledge base 330 may include in-house proprietary information, or may include open-source data, or a combination.

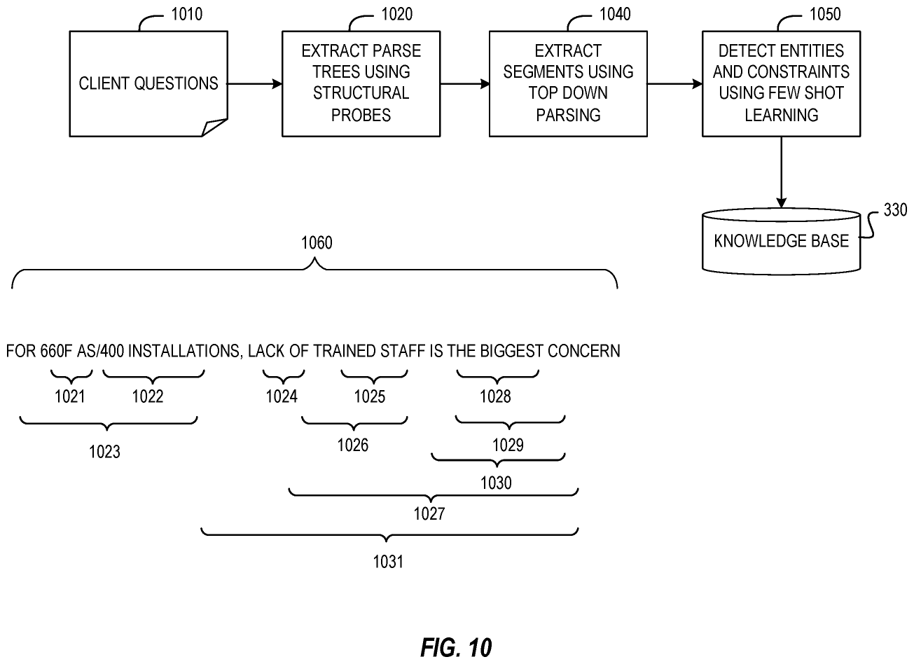

In embodiments, the environment includes running a number of input case studies 303 through a neural word segmentation techniques process 305, and to identify the problem statements 301 provided by clients in the various case studies. The neural word segmentation process 305 may be implemented using NLP and NLU machine learning models and is described in more detail in conjunction with FIG. 10, below. Neural word segmentation may be performed by a module of code of block 200 of FIG. 1. In an example, extraction of technical entities is performed in block 331 and stores the information in knowledge base 330. Knowledge base 330 may be stored in a computer readable medium such as persistent storage 113 of FIG. 1. In another embodiment, the knowledge base 330 may be stored in a remote database 130 as in FIG. 1. Extraction of business constraints may be identified in block 333 and saved in knowledge base 330. Extraction of relationships such as entity and business constraints may be identified in block 335. Extraction of relationships such as disposition to entity and entity to business constraint may be identified in block 337. Extraction of workflows generation may be identified in block 339.

Examples of the problem statement 301 criteria are shown in blocks A-E 310A-E. In an example, criteria A 310A includes increasing licensing cost, maintenance fees, decreasing availability of IT resources, vendor lock-in, and use of proprietary technology. In this example, additional information regarding the problem statement includes B 310B identifying legacy applications/databases such as mainframe, z/OS, Linux, Natural Programming Language, Adabas, VSAM, and Oracle. A further criteria of the problem statement may include C 310C where the legacy mainframe drives increasing licensing cost, Natural Programming Language uses proprietary technology, and decreasing availability of IT resources are identified. In this example, the language in D 310D is the same as in C 310C. However, C 310C is processed through extraction block 335 and D 310D is processed through extraction block 337 to both extract relationships of entity to business constraints (335), and extract relationships of disposition to entity and entity to business constraints (337). In this example, E 310E includes criteria for migrate (z/OS→Linux)→migrate (Natural Programming Language→Java)→migrate (VSAM→Oracle). E 310E is processed through the extraction of workflows generation block 339.

The extraction blocks 331-339 provide entities and constraints F-J 310F-J. Extraction block 331 extracts technical entities from the input data and in this example provides formatted data “MVS/z/OS, Linux, Natural Programming Language, ADABAS, VSAM, Oracle Database” to be stored in the knowledge base 330. Business constraints, for example, “cost of ownership, resource availability, and proprietary tools” formatted information is extracted in extraction block 333 for knowledge base 330. In this example, extraction for relationships <Entity, Business Constraint> in block 335 provides formatted constraints for the knowledge base 330, such as “<MVS|Z/OS, Cost of ownership>, <Natural Programming Language, proprietary tools>. Relationship extraction for Extraction of Relationships <Disposition, Entity|Entity, Business Constraint> in block 337 provides formatted constraints for the knowledge base 330, such as “<MVS|Z/OS, Cost of ownership, Linux, replatform>, <Natural Programming Language, proprietary tools, Java, translate>.” And the Extraction of workflows generations in block 339 provides formatted data such as “replatform (z/OS→Linux)→refactor (Natural Programming Language→Java)→replatform (VSAM→Oracle)” for knowledge base 330.

In an embodiment, the knowledge base 330 includes structured data extracted in blocks 331-339 and formatted from unstructured data A-F 310A-F for knowledge augmentation. Data from previous case studies is structured to help enable AI-based disposition recommendations using machine learning. For instance, the knowledge base 330 may provide information that shows an average cost of migration of one million lines of COBOL code to JAVA, or average cost to rehost an application from an obsolete platform onto a state-of-the-art platform or cloud environment. A provided problem statement may include the client's budget. Knowledge base 330 may correlate business constraints extracted in 331-339 with certain disposition items at a broader level based on augmented knowledge in knowledge base 330, where the information has been augmented using other case studies. For instance, if a client business constraint is to reduce cost of ownership of applications, the “reduce cost of ownership” keywords may trigger certain disposition parts, such as “migrate to Linux” because the information in knowledge base 330 correlates this business constraint to the Linux migration disposition at a high level. At this point in the process of modernization disposition, NLP/NLU are used 331-339 to broadly identify the business constraints and technical/non-technical entities 310A-E to generate a broad set of possible disposition correlations 310F-J using the knowledge base 330.

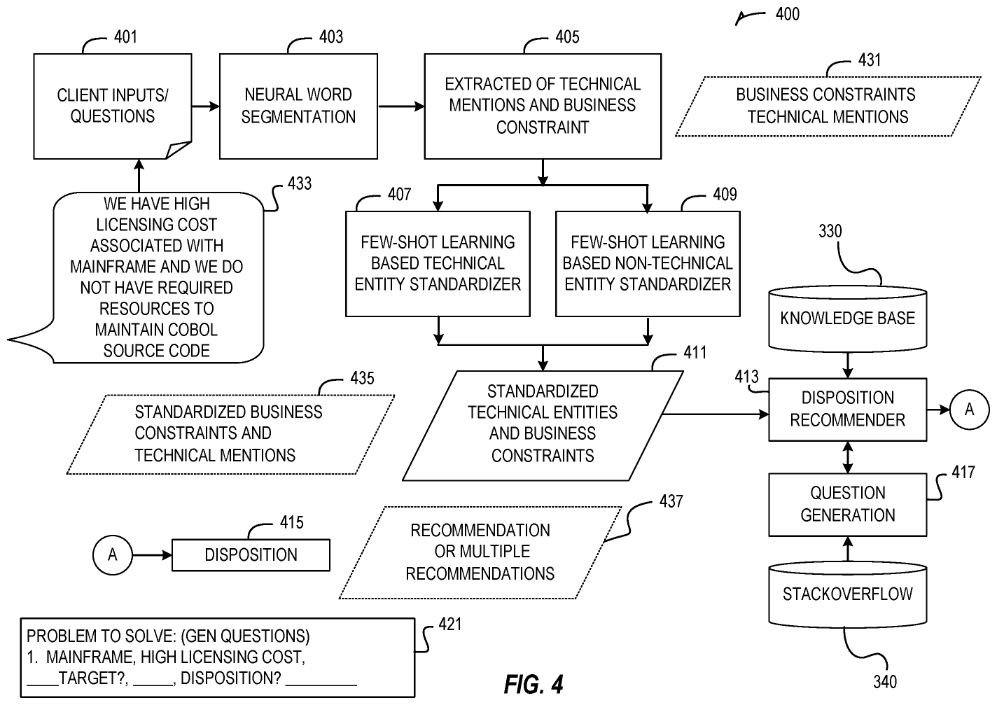

FIG. 4 is a flow diagram depicting an exemplary method 400 for application modernization disposition, according to an embodiment, where targets are not provided. This method 400 may be performed by a module of code of block 200 of FIG. 1. In this context, a target is a proposed migration change provided by the client, such as a suggestion of where the client may want to host the application, or a preferred language for migration. The flow diagram in FIG. 4 generally corresponds to the environment in FIG. 3. A client provides inputs and questions related to their legacy application(s) at block 401. The inputs are typically provided in natural language using either text or spoken words converted to natural language text 433. The unstructured client questions 433 are input to the neural word segmentation process at block 403. In embodiments, structured questions such as shown in 421 may also be input instead of, or in addition to, the unstructured questions 433. Business constraints and technical mentions 431 of the client input 433 are extracted in block 405. A few-shot learning model may be used to standardize technical entities parsed from the client input, in block 407. Few-Shot Learning (FSL) is a machine learning framework that enables a pre-trained model to generalize over new categories of data (that the pre-trained model has not seen during training) using only a few labeled samples per class. A FSL model is also used to standardize non-technical entities parsed from the client input, in block 409. In an example, the extraction in block 405 may provide business constraints of “high licensing cost, required resources to maintain COBOL source code;” Technical Mentions might include: “Mainframe, COBOL” at 431.

In an example, the standardized technical entities and business constraints 411 may be derived as standardized business constraints of total cost of ownership, and resource availability. In an example, the standardized technical mentions may be: MVS|z/OS, and COBOL, as shown in block 435. The standardized business constraints and technical mentions 435 are provided to the disposition recommender process 413. Other publicly available databases such as Stackoverflow 340 may be used to access data from crowdsourced previous case studies and user questions. Stackoverflow is a secure collaboration and knowledge sharing platform that creates a collective knowledge base. In an embodiment, question generation process 417 generates formatted questions using the standardized business constraints and technical entities to scrape information from Stackoverflow database 340. Providing a formatted question to Stackoverflow 340 returns cases studies that may have similar technical mentions, business constraints, etc., as defined in the client's input questions 401. Disposition recommender process 413 may use information from Stackoverflow database 340 as well as knowledge base 330 to identify similar cases studies. The disposition recommender uses a trained machine learning model to identify and correlate similarities between the client's input questions and hundreds, thousands, or even millions of case study information available from the databases to provide one or more output recommendations 437 in a disposition 415 to modernize the client's applications and/or hardware systems. In an example, based on the client's questions and constraints extracted from client inputs/questions 433, 421, several recommended dispositions 437 may include: (a) Replatform (MVS|z/OS to Linux), (b) Replatform (MVS|z/OS to Windows), (c) Refactor (COBOL to Java), and (d) Refactor (COBOL to C#). The disposition recommended 413 identifies which of the possible recommendations 437 has more support or are easier to implement, etc. Disposition recommender 413 may mine the data in Stackoverflow 340 to aid in the selection of the best disposition, based on previous case studies.

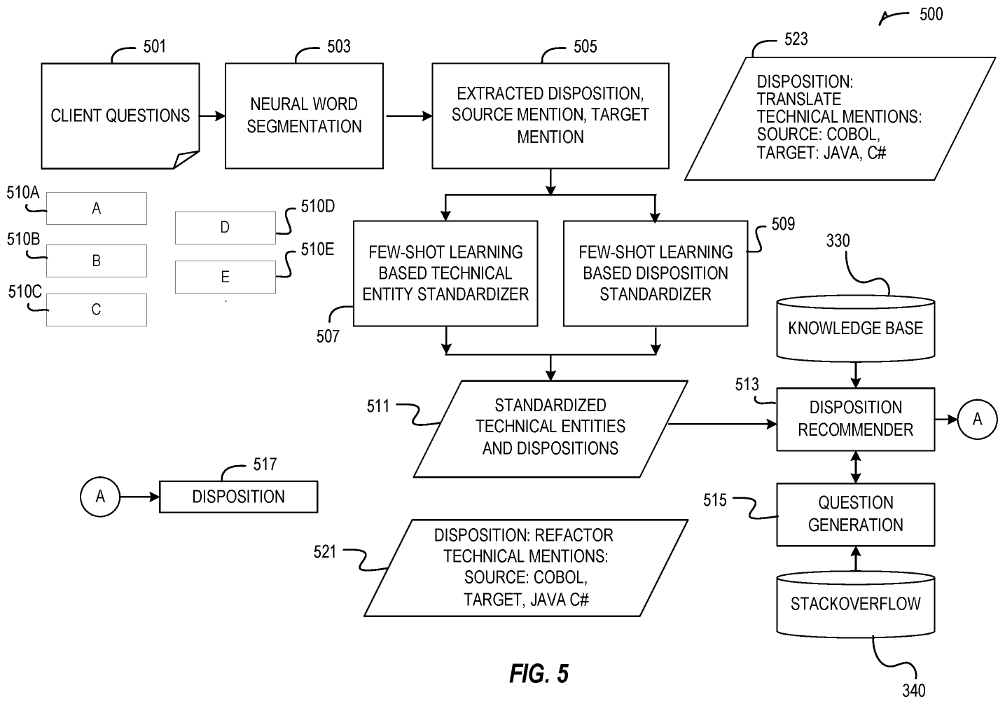

FIG. 5 is a flow diagram depicting an exemplary method 500 for application modernization disposition, according to an embodiment, where the client provides preferred targets. Method 500 may be performed by a module of code of block 200 of FIG. 1. For instance, in an example, the client may already plan to migrate code to Java and is looking for a cost effective and viable path. A preferred target is a user preference for aspects of the disposition. In this example, Java would be included in the user disposition preferences. Client questions 501 may be in the form of questions A-E 510A-E. In an example question A 510A is “Should I translate COBOL to Java or C#”? Question B 510B may be “Which is better? Moving from VSAM to Oracle Database or DB2”? Question C 510C may be “Which is better in terms of scalability? Oracle Database or DB2”? Question D 510D may be “Can I translate COBOL to Java or C#”? And question E 510E may be “Which is better? Oracle Database or DB2”? Questions A-E 510A-E are used as input to neural word segmentation technique process 503 to provide extracted disposition, source mention, and target mention data at block 505. The extracted disposition and mentions are provided as input to few-shot learning-based technical entity standardizer at block 507. The extracted disposition and mentions are also provided as input to few-shot learning-based disposition standardizer at block 509. The standardized outputs from blocks 507 and 509 are provided as standardized technical entities and dispositions at block 511.

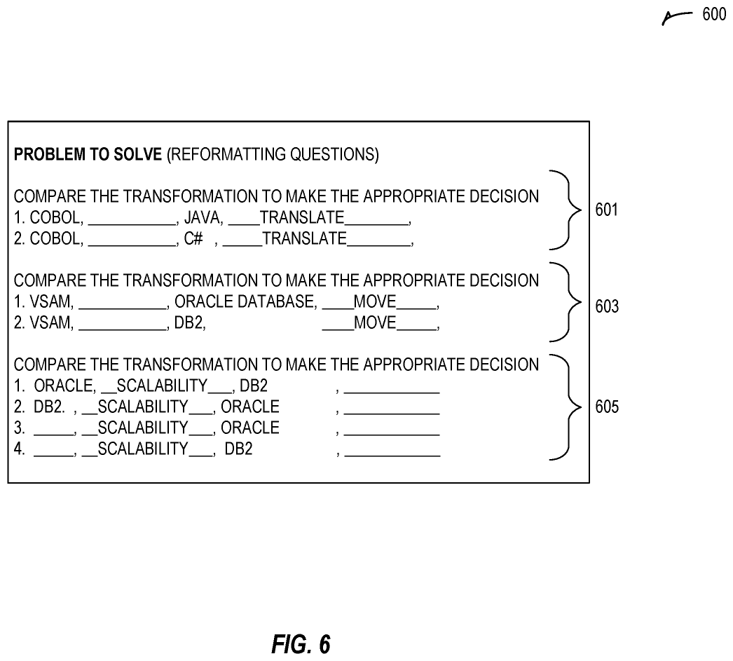

In an example, the extracted disposition 523 from block 505 may be a disposition to translate. Technical mentions source is COBOL, and the target, i.e., user disposition preference, is Java and C#. In this example, the disposition output 521 of disposition recommender 513 is to refactor, and the technical mention source is COBOL, and the target is Java and C#. FIG. 6 illustrates a set of reformatted questions 600 that correspond to the client's problem to be solved. In an example, various transformations are left open to compare with respect to language transformation 601, database transformation 603, and database scalability issues 605. Referring again to FIG. 5, based on the disposition using the questions of FIG. 6, the disposition recommender at block 513 may use case study information provided from knowledge base 330 and Stackoverflow database 340. As in FIG. 4, block 417, question generation 515 generates formatted questions using the standardized business constraints and technical entities to scrape information from Stackoverflow database 340 to identify cases studies that may have similar technical mentions, business constraints, etc., as defined in the client's input questions. The disposition recommender 513 runs the relevant case study information from Stackoverflow database 340 and knowledge base 330 through a trained machine learning model with the client's question information and provides disposition 517. In an example with the questions 510A-E and reformatted questions as in FIG. 6, the disposition may be a recommendation to refactor from COBOL to Java code, as in 521.

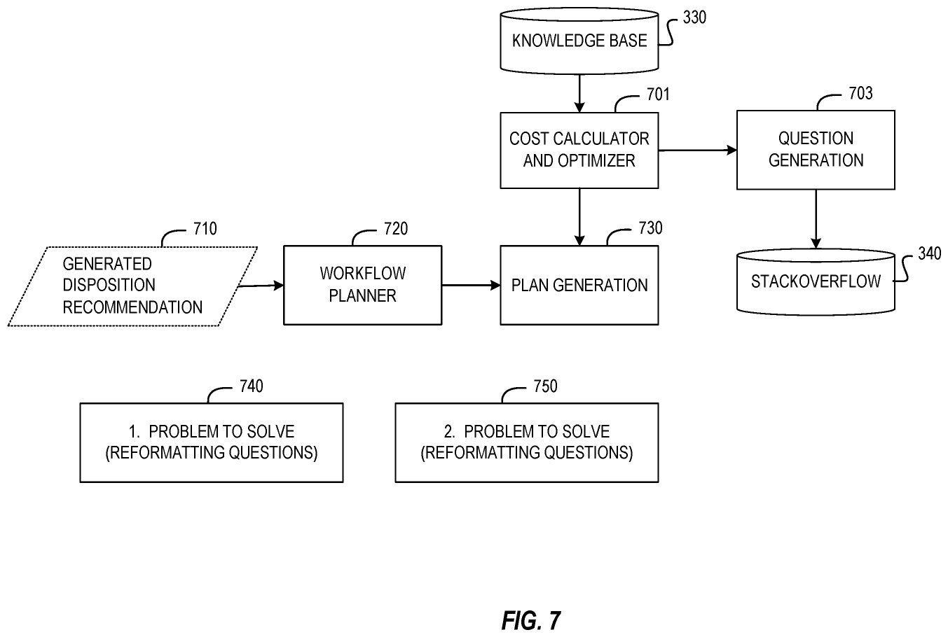

FIG. 7 is a flow diagram depicting a method for application modernization workflow planning, according to an embodiment. In an embodiment, a generated disposition recommendation 710 is input to a workflow planner 720. In an embodiment, when a client has selected a recommended disposition, workflow planner 720 may be used to provide a workflow for the client to follow to implement the selected disposition, Workflow planner 720 may be a set of program instructions executed in computer 100, as shown in FIG. 1, in execution block 200 and stored in persistent storage 113. Workflow planner 720 uses the generated disposition recommendation 710 provided by the disposition recommender, and selected by the client, as described above, to generate a plan for modernization in block 730. The plan generation process 730 uses case study information from the knowledge base 330 and Stackoverflow database 340 to help provide a viable plan for modernization. A cost calculator and optimizer process 701 is executed on the processor set to retrieve case study information from knowledge base 330. The cost calculator and optimizer process generates formatted questions in block 703 to query the Stackoverflow database 340 to get additional data relevant to the client's modernization issues. In an embodiment, the workflow planner 720 will not use machine learning, but knowledge augmentation with Stackoverflow data may use machine learning models to summarize responses from Stackoverflow database 340 in plan generation 730. Plan generation 730 may generate a single direct response with a confidence score for the question/problem that was posed to Stackoverflow database 340.

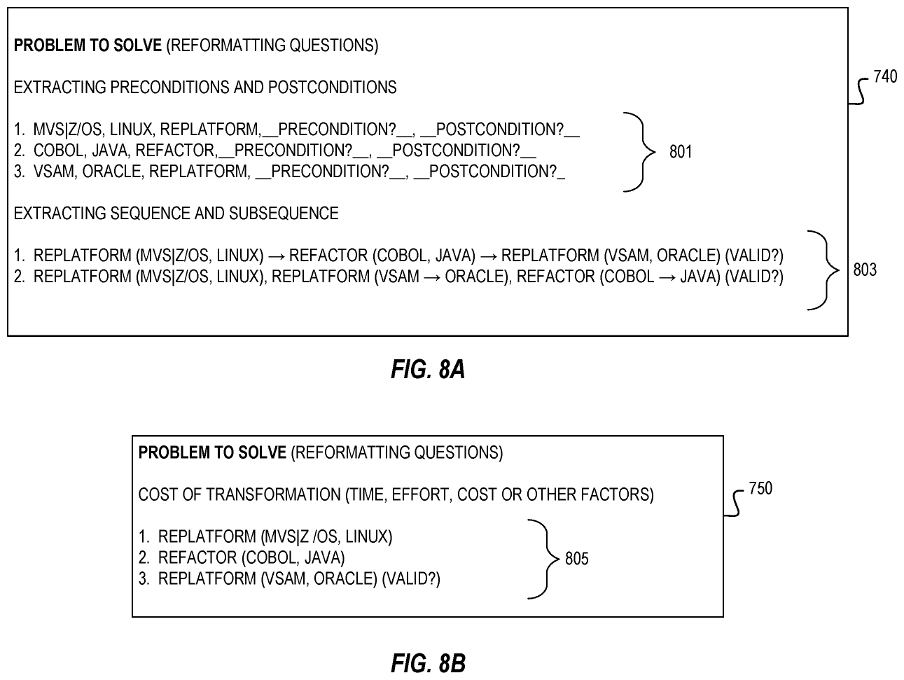

In an example, reformatted questions 740, 750 are shown in more detail in FIG. 8A and FIG. 8B. FIG. 8A shows an exemplary set of reformatted questions to describe the client's problem 740. A set of preconditions and postconditions 801 are extracted from the client's natural language description of the problem, as described above. A set of sequence and subsequences 803 are extracted from a disposition recommendation 710 to be used as input into workflow planner 720. Additional problems to be solved 750 are shown in more detail in FIG. 8B. FIG. 8B illustrates cost of transformation questions 805 in the form of replatform and refactor disposition tasks.

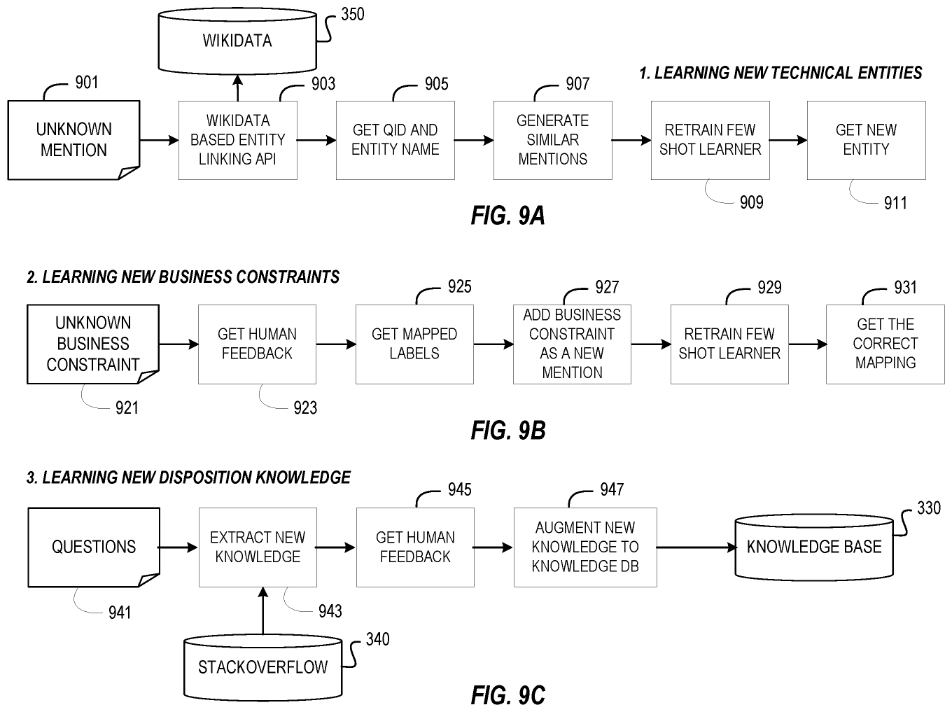

FIGS. 9A-C depict a series of flow diagrams illustrating active learning for application modernization machine learning models, according to an embodiment. When a client enters information in a question that has not previously been identified in the machine learning models, case study information and human feedback may be required to properly identify and categorize the unknown element before a disposition can be recommended by the disposition recommender machine learning model.

FIG. 9A illustrates active learning of new technical entities, according to an embodiment. A client may provide an unknown mention in question 901. In an embodiment, a WikiData-based entity may use a linking application program interface (API) 903 to retrieve data from a WikiData database 350 that corresponds to the unknown entity. A unique identifier, QID, may be associated with an entity name retrieved from the WikiData database 350 in block 905. Similar mentions are generated in block 907 and used as input to a machine learning model for retraining the machine learning model to identify and correlate entities in block 909. In an embodiment, a few-shot learning machine learning model is used and retrained with the retrieved entity data and mentions. Finding a new entity in WikiData can be considered zero-shot learning, because the entity standardization model has never seen any entity from that mention before. However, after the mentions for that entity are generated, the few-shot learning model is retrained using those mentions. Once the model has been retrained, the unknown entity is provided in block 911 as a new entity for use in the disposition recommender and plan generator. In an embodiment, the new entity information is added as augmented knowledge in knowledge base 330. In an embodiment, sources other than WikiData may be used to identify the unknown mention for knowledge augmentation.

FIG. 9B illustrates active learning of new business constraints, according to an embodiment. It will be understood that each client may have their own unique business constraints, so human feedback may be necessary to fully define the constraints. A client may provide an unknown business constraint in a question 921. In an embodiment, the business constraint is provided to a human, possibly a subject matter expert (SME) for the client's business, in block 923. The SME provides feedback and then provides mapped labels for the business constraint in block 925. The new business constraint is added as a new mention in block 927. The zero-shot learning model may be retrained with the new mention in block 929. This technique may be identified as supervised learning because human labeling is used. Once the machine learning model has been retrained, the previously unknown business constraint will be properly mapped in block 931 to a new mention, understood by the machine learning model.

FIG. 9C illustrates active learning of new disposition knowledge, according to an embodiment. In an embodiment, the client's question 941 is used as input to retrieve answers and extract new knowledge from the Stackoverflow database 340, in block 943. Human feedback may be provided in block 945 to refine this new knowledge. The new knowledge derived from the Stackoverflow database 340 is then used to augment the knowledge base 330 in block 947.

FIG. 10 is a flow diagram illustrating neural word segmentation, according to an embodiment. In an embodiment, a remote NLP model hosted on a cloud server may be used to parse the words in a natural language input. In another embodiment, a local NLP communicatively coupled to computer 101 may be used. A client question is provided in block 1010. In an example, the client question 1060 is “For 660F AS/400 installations, lack of trained staff is the biggest concern.” The sentence 1060 is input to process block 1020 to extract parse trees using structural probes. The sentence may be parsed and then segmented in block 1040 using top-down parsing as shown. For instance, “660F AS/” 1021 and “400 installations” 1022 may be segmented from “For 660F AS/400 installations” 1023 using a semantic parser using NLU. The term “lack of” 1024 may be identified as a segment because it is a known mention for this type of modernization. Further segmentation such as “trained staff” 1025, may be segmented from “of trained staff” 1026, as a known entity for the business. “The biggest” 1028 may be segmented from “the biggest concern” 1029 as a semantically important mention. The initial segmentation of “Lack of trained staff is the biggest concern” 1031 may be segmented to “trained staff is the biggest concern” 1027 and then further segmented as above to provide semantic segments that correspond to mentions or entities in the case study. Once the segments have been parsed, generating parse trees, the entities, mentions, and constraints are detected using few-shot learning model in block 1050. In this example the parse trees provide non-technical entities including “For 660f AS/400 installations {None},” and “Lack of trained staff is the biggest concern {resource availability}.” Technical entities detected are “660f AS/400 {AS/400},” and “AS/400 installations {AS/400}.” The detected entities, mentions and constraints are then correlated and stored in the knowledge base 330 for use with the disposition recommender and planner models.

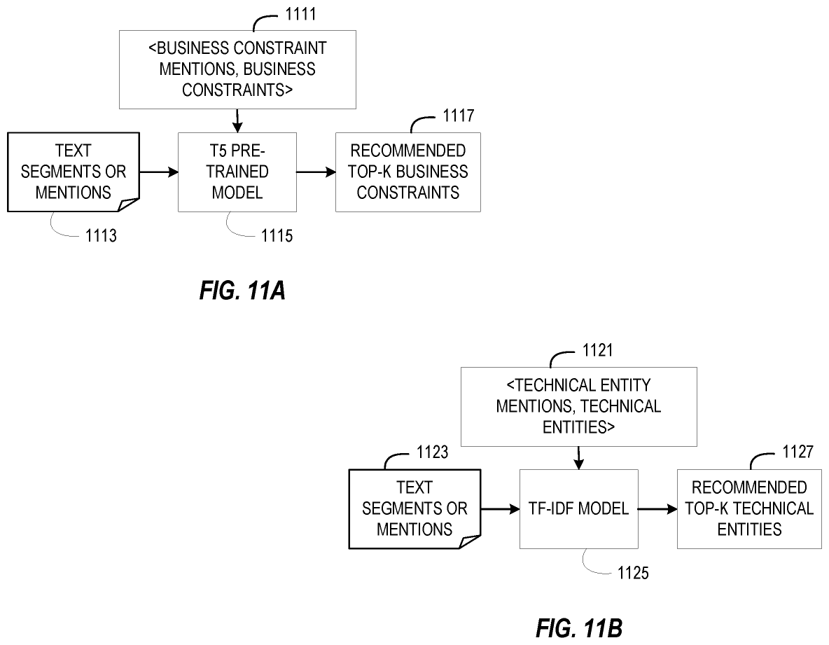

In an embodiment, as discussed above, few-shot learning is used to provide deep machine learning models for modernization disposition and planning. FIGS. 11A-B illustrate flow diagrams of few-shot learning, according to an embodiment. A text-to-text transfer transformer model is a transformer-based architecture that uses a text-to-text approach. Every task, including translation, question answering, and classification, is cast as feeding the model text as input and training it to generate some target text. A third-party model, T5, is currently available from Google, Inc. T5 is pre-trained on a large-scale dataset called Colossal Clean Crawled Corpus (C4). C4 is an open-source pre-training dataset which may achieve state-of-the-art results on many NLP benchmarks. Embodiments as described herein may use T5 for business constraints to address long entity types. A term frequency-inverse document frequency (TF-IDF) model is used for technical entity recognition, in an embodiment. A TF-IDF model is a numerical statistic that is intended to reflect how important a word is to a document in a collection or corpus. It is often used as a weighting factor in searches of information retrieval, text mining, and user modeling. The TF-IDF value increases proportionally to the number of times a word appears in the document and is offset by the number of documents in the corpus that contain the word, which helps to adjust for the fact that some words appear more frequently in general. TF-IDF is a popular term-weighting scheme used in current systems.

Referring to FIG. 11A, business constraint mentions and business constraint information 1111 are input to further train the T5 model at 1115. The business constraints mentions (e.g., text segments containing business constrains mentions) 1113 are derived from the use cases data and are used to fine-tune the pre-trained T5 model 1115 so that the T5 model can recognize mentions of business constraints from clients/users. The input that was used to pre-train the initial T5 model, i.e., C4 dataset, is simple English text without any knowledge of what a business constraint is. The text segments or mentions 1113 extracted from the client's question/problem are input to the pre-trained T5 model in block 1115 to augment the model. The model outputs the top-K recommended business constraints in block 1117. A similar process is used for recommended technical entities in FIG. 11B.

Referring to FIG. 11B, technical entity mentions and technical entity information 1121 is input to further train the TF-IDF model at 1125. The text segments or mentions 1123 extracted from the client's question/problem are input to the pre-trained TF-IDF model in block 1125 to augment the model's knowledge. The TF-IDF model is different than the T5 model. In an embodiment, the TF-IDF model is trained on a dataset of technical entity mentions that have been mined from known use cases, such as the knowledge base 330, or other data that has been mined from third party databases. In an embodiment, the TF-IDF data model may undergo supervised training to provide a robust model that recognizes many common technical entities. The TF-IDF model outputs the top-K recommended technical entities 1127.

It will be understood that the methods discussed with respect to FIGS. 11A and 11B are for illustrative purposes. The operations of FIGS. 11A and 11B may look similar, but they use two distinct models. The T5 model recognizes mentions of business constraints, while the TF-IDF model recognizes mentions of technical entities. For purposes of discussion herein, the term machine learning model may be used to describe both models. In alternative embodiments, the models may be trained on datasets derived from third party information, proprietary information, supervised or labeled datasets, or a combination of different types of datasets derived from disparate sources. For purposes of discussion herein, it will be understood that in the example illustrated, the model identified as T5 model will recognize business constraints. In contrast, the model identified as the TF-IDF model recognized technical entities. In embodiments, a BERT transformer could be used, or a single machine learning model could be trained to recognize both business constraints and technical entities.

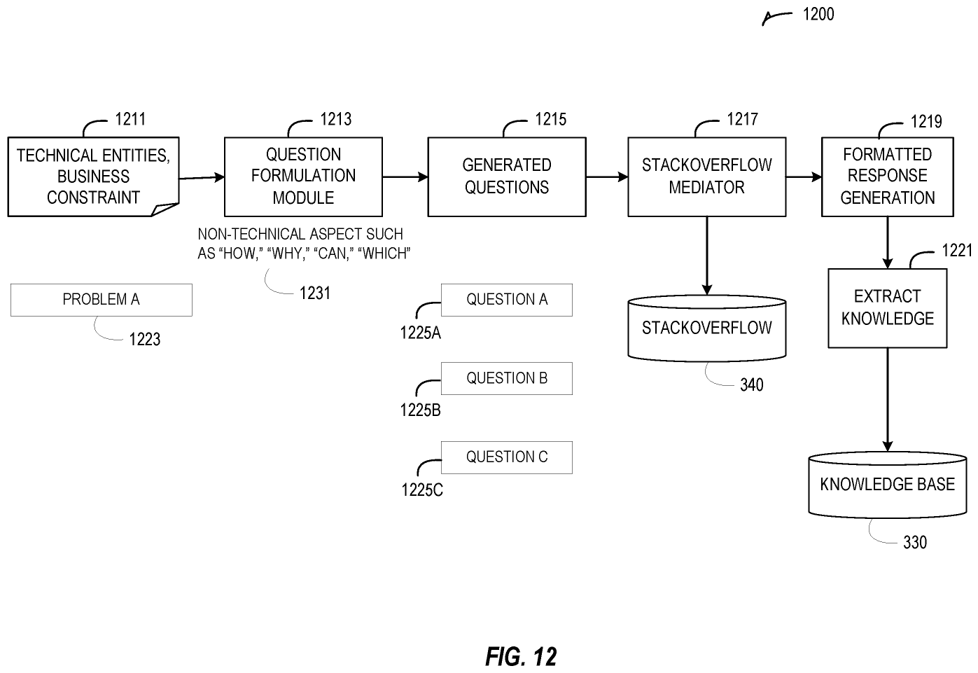

FIG. 12 is a flow diagram illustrating a method 1200 for question generating, according to an embodiment. Technical entities and business constraints 1211 are input to a question formulation module 1213. An example problem A 1223 is “Mainframe, high licensing cost.” In an embodiment, the question formulation module 1213 comprises a set of program instructions to be executed on a processor set and may be operated locally or remotely, for instance on a cloud server. The question formulation module 1213 helps formulate questions with the non-technical aspect 1231 such as the “how.” “why.” “can.” “which” parts of the question. Example questions A-C 1225A-C may include:
A 1225A: “How to reduce licensing cost for Mainframe”?
B 1225B: “Can I replatform Mainframe to Linux”?
C 1225C: “Which is better? COBOL to Java or COBOL to C#”?

Once the questions 1225A-C are generated in block 1215, they are provided to the Stackoverflow mediator 1217. The term Stackoverflow mediator is used herein to refer to a module (i.e., set of program instructions) that given the generated questions, mines Stackoverflow 340 for answers and ranks the answers based on relevance with respect to the questions 1215, and formats them 1219 into a form that can be processed by the knowledge extraction module 1221 to augment the knowledge base 330. As discussed herein, the Stackoverflow mediator module 1217 may be implemented ad-hoc and is not meant to identify an existing functionality in Stackoverflow 340 designs. The Stackoverflow mediator 1217 generates the Top-K responses using information from the Stackoverflow database 340 and formats them to generate a desirable response. The formatted response is generated at block 1219. The formatted response is parsed to extract knowledge in block 1221. The extracted knowledge may be entered into the knowledge base 330 to augment the information with structured data and provide additional use case information related to the client's problem and various constraints, mentions and questions. The augmented information can then be used for future disposition recommendations.

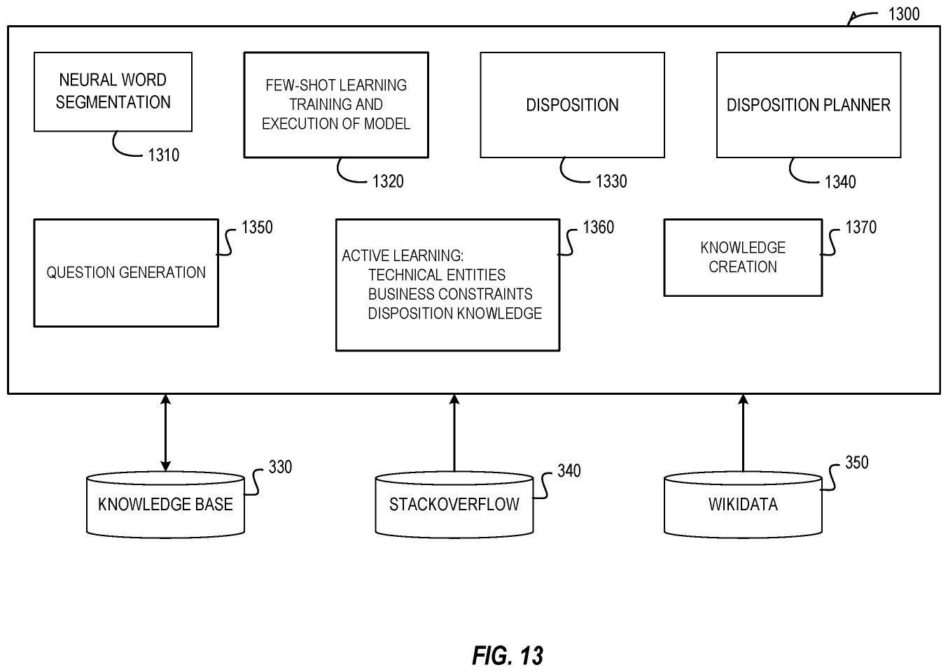

Referring to FIG. 13, in embodiments, the computing environment 100 of FIG. 1 comprises the application modernization disposition with machine learning process 200 which include modules for neural word segmentation 1310; machine learning model (e.g., few-shot learning models) and model training 1320; disposition generation 1330; disposition workflow planning 1340; question generation 1350; active learning of technical entities, business constraints, disposition knowledge 1360; and knowledge creation 1370, as discussed above corresponding to FIGS. 3-12. Each of the modules 1310, 1320, 1330, 1340, 1350, 1360, and 1370 may comprise modules of the code of block 200 of FIG. 1. These modules of the code of block 200 are executable by the processing circuitry 120 of FIG. 1 to perform the inventive methods as described herein. The computer 101 may include additional or fewer modules than those shown in FIG. 13. In embodiments, separate modules may be integrated into a single module. Additionally, or alternatively, a single module may be implemented as multiple modules. Moreover, the quantity of devices and/or networks in the environment is not limited to what is shown in FIG. 1. In practice, the environment may include additional devices and/or networks; fewer devices and/or networks; different devices and/or networks; or differently arranged devices and/or networks than illustrated in FIG. 1.

In an embodiment, the application modernization disposition process 1300 receives natural language input, or questions from a user needing modernization of one or more software or hardware systems. The natural language input (not shown) is used as input to neural word segmentation module 1310, as discussed in more detail above. One or more pre-trained machine learning models (e.g., few-shot learning models) 1320 are used to extract information from the natural language input, as discussed more fully above. This extraction includes extracting and understanding the user's problem as it corresponds to technical entities, business constraints, and disposition knowledge, as discussed more fully above. One or more knowledge databases 330, 340, and 350 may be used to obtain use case information relevant to the user's problem statement, as discussed above.

In the course of obtaining knowledge from a database such as Stackoverflow 340, structured and formatted questions are formed from the problem statement by a question generation module 1350, as discussed above. Once the relevant data has been retrieved from the available sources 330, 340, and 350, one or more disposition recommendations are provided by the disposition module 1330. This process may vary, as discussed above, depending on whether the user has provided a preferred target for the modernization. Once the user has selected one or more dispositions, a workflow plan, which may include step-by-step instructions for implementation, is generated by the disposition planner module 1340. During the NLP/NLU processing of the problem statement, new technical entities, business constraints, and disposition knowledge may be discovered with active learning module 1360 and formatted for storage in knowledge base 330 for aiding the disposition module 1330 and for future use by knowledge creation module 1370.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a processor set of computing device, such as processor set 110 of computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, a natural language problem statement corresponding to application modernization needs of a user, the natural language problem statement including at least one technical entity, business constraint, and disposition information;
providing, by the processor set, extracted structured information by extracting information from the natural language problem statement using a neural word segmentation method;
generating, by the processor set, standardized technical entities, standardized business entities, and standardized dispositions by inputting the extracted structured information to at least one machine learning model; and
generating, by the processor set, at least one recommended disposition of at least one technical entity to a second technical entity based at least on a business constraint corresponding to the natural language problem statement using the standardized technical entities, standardized business entities, and standardized dispositions.

2. The method as recited in claim 1, wherein
the at least one recommended disposition corresponds to one or more possible target environments along with explanation generated based on the business constraints and mentions of technical entities present in the natural language problem statement.

3. The method as recited in claim 2, further comprising:
retrieving structured knowledge corresponding to the natural language problem statement from at least one knowledge database by querying the at least one knowledge database with the extracted structured information,
wherein at least one of the at least one knowledge database includes use case knowledge bootstrapped from use case studies that contain disposition recommendations from one technical entity to another given a business constraint, or a publicly available database having crowdsourced information corresponding to technical entities, business constraints and disposition solutions.

4. The method as recited in claim 1, wherein the natural language problem statement includes user disposition preferences including at least one of a preferred modernized target environment and a preferred transformation path, and further comprising:
generating the at least one recommendation disposition corresponding to the natural language problem statement to consider the at least one of a preferred modernized target environment and a preferred transformation path, and the user disposition preferences, the generating including validating the user disposition preferences against recommended dispositions provided by the disposition recommender process; and
modifying the at least one recommended disposition to accommodate the user disposition preferences.

5. The method as recited in claim 1, wherein the extracting information from the natural language problem statement further comprises:
using at least one natural language processing and natural language machine learning model to:
extract technical entity information, business constraint information, relationship information correlating between entities and business constraints, and relationship information correlating dispositions to entities and entities to business constraints from the natural language problem statement;
extract workflow planning corresponding to the natural language problem statement and the at least one recommended disposition, wherein the workflow planning includes at least one transformation path;
providing structured knowledge using the natural language machine learning model, the structured knowledge corresponding to both the natural language problem statement and the at least one recommended disposition, by correlating the extracted technical entity information, the extracted business constraint information, the extracted relationship information correlating between entities and business constraints, the extracted relationship information correlating dispositions to entities, and entities to business constraints, and the extracted workflow planning; and
augmenting a knowledge base of structured use case information with the structured knowledge corresponding to both the natural language problem statement and the at least one recommended disposition.

6. The method as recited in claim 5, wherein augmenting the knowledge base further comprises:
validating new information in terms of new business constraints, new technical entities, new transformation paths, and user disposition preferences to improve the existing knowledge base, wherein validating includes accessing publicly available knowledge databases using structured information corresponding to at least one of the natural language problem statement, the at least one recommended disposition, and the at least one transformation path.

7. The method as recited in claim 5, responsive to the user selecting one of the at least one recommended dispositions, identifying a workflow plan based at least in part on user-based criteria corresponding to business constraints in the natural language problem statement, cost to implement the selected disposition, available resources, and time to complete.

8. The method as recited in claim 1, further comprising:
training the at least one machine learning model with the structured information, wherein the at least one machine learning model are pre-trained using a publicly available large-scale dataset.

9. A computer program product comprising one or more computer readable storage media having program instructions collectively stored on the one or more computer readable storage media, the program instructions executable to:
receive a natural language problem statement corresponding to application modernization needs of a user, the natural language problem statement including at least one technical entity, business constraint and disposition information;
provide extracted structured information by extracting information from the natural language problem statement using a neural word segmentation method;
generate standardized technical entities, standardized business entities, and standardized dispositions by inputting the extracted structured information to at least one machine learning model; and; and
generate at least one recommended disposition of at least one technical entity to a second technical entity based at least on a business constraint corresponding to the natural language problem statement using the standardized technical entities, standardized business entities, and standardized dispositions, the at least one recommended disposition corresponding to one or more possible target environments along with explanation generated based on the business constraints and mentions of technical entities present in the natural language problem statement.

10. The computer program product as recited in claim 9, further comprising program instructions executable to:
retrieve structured knowledge corresponding to the natural language problem statement from the at least one knowledge database by querying the at least one knowledge database with the extracted structured information.

11. The computer program product as recited in claim 10, wherein at least one of the at least one knowledge database includes use case knowledge bootstrapped from use case studies that contain disposition recommendations from one technical entity to another given a business constraint, and
wherein at least one of the at least one knowledge database includes a publicly available database having crowdsourced information corresponding to technical entities, business constraints and disposition solutions.

12. The computer program product as recited in claim 9, wherein the natural language problem statement includes user disposition preferences including at least one of a preferred modernized target environment and a preferred transformation path, and further comprising program instructions executable to:
generate the at least one recommendation disposition corresponding to the natural language problem statement, based at least on the at least one of a preferred modernized target environment and a preferred transformation path, and user disposition preferences, the generating including validating the user disposition preferences against recommended dispositions provided by the disposition recommender process; and
modify the at least one recommended disposition to accommodate the user disposition preferences.

13. The computer program product as recited in claim 9, wherein the extracting information from the natural language problem statement further comprises program instructions executable to:
use at least one natural language processing and natural language machine learning model to:
extract technical entity information, business constraint information, relationship information correlating between entities and business constraints, and relationship information correlating dispositions to entities and entities to business constraints from the natural language problem statement;
extract workflow planning corresponding to the natural language problem statement and the at least one recommended disposition, wherein the workflow planning includes at least one transformation path;
provide structured knowledge using the natural language machine learning model, the structured knowledge corresponding to both the natural language problem statement and the at least one recommended disposition, by correlating the extracted technical entity information, the extracted business constraint information, the extracted relationship information correlating between entities and business constraints, the extracted relationship information correlating dispositions to entities, and entities to business constraints, and the extracted workflow planning; and
augment a knowledge base of structured use case information with the structured knowledge corresponding to the natural language problem statement, and the at least one recommended disposition.

14. The computer program product as recited in claim 13, wherein augmenting the knowledge base further comprises program instructions executable to:
validate new information in terms of new business constraints, new technical entities, new transformation paths, user disposition preferences to improve the existing knowledge base, wherein validating includes accessing publicly available knowledge databases using structured information corresponding to at least one of the natural language problem statement, the at least one recommended disposition, and the at least one transformation path.

15. The computer program product as recited in claim 13, further comprising program instructions executable to:
identify a workflow plan based at least in part on user-based criteria corresponding to business constraints in the natural language problem statement, cost to implement the selected disposition, available resources, and time to complete, responsive to the user selecting one of the at least one recommended dispositions.

16. The computer program product as recited in claim 9, further comprising program instructions executable to:
train the at least one machine learning model with the structured information, wherein the at least one machine learning model are pre-trained using a publicly available large-scale dataset.

17. A system comprising:
a processor set, one or more computer readable storage media, and program instructions collectively stored on the one or more computer readable storage media, the program instructions executable to:
receive a natural language problem statement corresponding to application modernization needs of a user, the natural language problem statement including at least one technical entity, and business constraint—;
provide extracted structured information by extracting information from the natural language problem statement using a neural word segmentation method;
generate standardized technical entities, and standardized business entities, by inputting the extracted structured information to at least one machine learning model; and
retrieve structured knowledge corresponding to the natural language problem statement from the at least one knowledge database by querying the at least one knowledge database with the extracted structured information; and
generate at least one recommended disposition of at least one technical entity to a second technical entity based at least on the structured knowledge corresponding to the natural language problem statement from the at least one knowledge database, a business constraint corresponding to the natural language problem statement using the standardized technical entities and standardized business entities.

18. The system as recited in claim 17, wherein the at least one recommended disposition corresponds to one or more possible target environments along with explanation generated based on the business constraints and mentions of technical entities present in the natural language problem statement, and further comprising program instructions executable to:
generate the at least one recommendation disposition corresponding to the natural language problem statement to consider the at least one of a preferred modernized target environment and a preferred transformation path, and user disposition preferences, the generating including validating the user disposition preferences against recommended dispositions provided by the disposition recommender process, wherein the natural language problem statement includes user disposition preferences including at least one of a preferred modernized target environment and a preferred transformation path; and
modify the at least one recommended disposition to accommodate the user disposition preferences.

19. The system as recited in claim 17, wherein the extracting information from the natural language problem statement further comprises program instructions executable to:
use at least one natural language processing and natural language machine learning model to:
extract technical entity information, business constraint information, relationship information correlating between entities and business constraints, and relationship information correlating dispositions to entities and entities to business constraints from the natural language problem statement;
extract workflow planning corresponding to the natural language problem statement and the at least one recommended disposition, wherein the workflow planning includes at least one transformation path;
provide structured knowledge using the natural language machine learning model, the structured knowledge corresponding to both the natural language problem statement and the at least one recommended disposition, by correlating the extracted technical entity information, the extracted business constraint information, the extracted relationship information correlating between entities and business constraints, the extracted relationship information correlating dispositions to entities, and entities to business constraints, and the extracted workflow planning; and
augment a knowledge base of structured use case information with the structured knowledge corresponding to the natural language problem statement, and the at least one recommended disposition.

20. The system as recited in claim 19, wherein augmenting the knowledge base further comprises program instructions executable to:
validate new information in terms of new business constraints, new technical entities, new transformation paths, and user disposition preferences to improve the existing knowledge base, wherein validating includes accessing publicly available knowledge databases using structured information corresponding to at least one of the natural language problem statement, the at least one recommended disposition, and the at least one transformation path.
